(19) United States
(12) Patent Application Publication
(10) Pub. No.: US 2025/0317330 A1
(43) Pub. Date: Oct. 9, 2025

(54) METHODS AND SYSTEMS FOR ADAPTIVE SOUNDING REFERENCE SIGNAL CONFIGURATION BASED ON AI-ASSISTED PHYSICAL LAYER INSIGHT

(71) Applicant: AIRA TECHNOLOGIES, INC., Saratoga, CA (US)

(72) Inventors: Prasad CHIVAKULA, San Jose, CA (US); Chandra Sekhar Tedla, Mountain View, CA (US); Gautham Hariharan, Sunnyvale, CA (US); Sandeep Kesireddy, San Jose, CA (US); Ravikiran Gopalan, Saratoga, CA (US)

(21) Appl. No.: 19/246,476

(22) Filed: Jun. 23, 2025

Related U.S. Application Data
(63) Continuation-in-part of application No. 19/039,109, filed on Jan. 28, 2025.
(60) Provisional application No. 63/626,431, filed on Jan. 29, 2024.

(51) Int. Cl. H04L 25/02; H04L 5/00; H04L 27/26

(52) U.S. Cl. CPC H04L 25/0224; H04L 5/0048; H04L 27/261

(57) ABSTRACT

A method and system are disclosed for dynamically scheduling sounding reference signals (SRS) in a wireless communication system based on physical-layer insights derived from channel estimation data. A machine-learned model processes the channel estimation data to extract metrics such as Doppler, delay spread, and signal-to-noise ratio (SNR), which are used by a base station scheduler to determine SRS transmission configurations for user equipment (UE). The scheduler adjusts parameters such as transmission periodicity and resource allocation based on coherence time, coherence bandwidth, and confidence levels of the extracted metrics. A control message conveying the updated configuration is transmitted to the UE. The system supports channel prediction to bridge SRS intervals and optimizes scheduling across multiple UEs based on correlated insight data.

### CROSS-REFERENCE TO RELEVANT APPLICATION

This application is a continuation-in-part of U.S. patent application Ser. No. 19/039,109, filed on Jan. 28, 2025, titled “SYSTEM AND METHODS FOR MACHINE LEARNING ASSISTED ANALYSIS OF CHANNEL ESTIMATES IN A RADIO ACCESS NETWORK,” which claims priority to and the benefit of U.S. Provisional Application No. 63/626,431, filed on Jan. 29, 2024, titled “SYSTEM AND METHODS FOR MACHINE LEARNING ASSISTED ANALYSIS OF CHANNEL ESTIMATES IN A RADIO ACCESS NETWORK,” the entire content of which are incorporated herein by reference in their entirety.

### TECHNICAL FIELD

The present disclosure relates generally to wireless communication systems, and more particularly to methods and systems for adaptive configuration of sounding reference signals (SRS) in Orthogonal Frequency Division Multiplexing (OFDM)-based networks such as 5G New Radio (NR). The adaptive configuration is enabled by AI-assisted physical layer insight.

### BACKGROUND

In 5G NR and other OFDM-based wireless systems, sounding reference signals (SRS) are uplink transmissions sent by user equipment (UE) to enable the base station (gNB) to estimate the reciprocal uplink channel when based on time-division duplexed systems. These uplink channel estimates can be used for downlink as well and are critical for tasks such as beamforming, link adaptation, and multi-user MIMO (MU-MIMO) scheduling. Traditionally, the scheduling and configuration of SRS—such as periodicity and frequency-domain resource allocation—are determined at the medium access control (MAC) layer using static or semi-static rules, without accounting for the dynamic behavior of the wireless channel.

However, the physical-layer characteristics of the channel can vary significantly over time and impact the validity duration of a channel estimate. Fixed SRS configurations fail to account for these dynamics, leading to inefficient use of radio resources, unnecessary UE battery drain, and degraded overall network throughput.

There is therefore a need for methods and systems that dynamically adjust SRS periodicity and resource allocation based on AI-assisted physical-layer metrics, enabling more efficient and context-aware scheduling that improves both radio resource utilization and UE power efficiency.

### SUMMARY

A system comprising one or more computers may be configured to perform specific operations by virtue of having software, firmware, hardware, or a combination thereof installed, such that when the system is operating, it performs the designated actions. Similarly, one or more computer programs may be configured to execute particular operations by including instructions that, when run by a data processing apparatus, cause the apparatus to perform those actions.

In one general aspect, a method may include receiving, at a base station, channel estimation data associated with a user equipment (UE). The method may further include processing the channel estimation data using a machine-learned model to generate one or more physical-layer insights. The method may also involve determining, by a scheduler at the base station, an SRS transmission configuration for the UE based on the generated physical-layer insights. In addition, the method may include generating a control message containing the SRS transmission configuration and transmitting that control message to the UE to update its SRS transmission parameters. Other embodiments of this aspect include corresponding systems, devices, and computer programs stored on one or more computer-readable storage media, each configured to perform the described actions.

Implementations may include one or more of the following features. The SRS transmission configuration may include at least one of a transmission periodicity or a resource allocation. The method may include selecting a number of channel prediction intervals to be used between consecutive SRS transmissions based on the selected transmission periodicity and adjusting the number of prediction intervals as needed to align with supported SRS periodicity values. The method may also include adjusting the transmission periodicity to the closest supported value from a predefined set of allowable SRS periodicities.

The physical-layer insights may include at least one of a Doppler value or a delay spread value. The method may include determining a coherence time for the wireless channel based on the Doppler value and selecting the SRS transmission periodicity based on that coherence time. In another example, the method may involve computing a predicted channel aging based on the Doppler value and a candidate transmission periodicity, comparing the predicted aging to a predefined hysteresis threshold, and selecting the candidate periodicity only if the predicted aging does not exceed the threshold.

The method may further include determining a coherence bandwidth for the wireless channel based on the delay spread value and using that to select a number of resource elements per physical resource block (PRB) to allocate for SRS transmissions. In addition, the method may involve deriving confidence scores for the Doppler and delay spread estimates based on a signal-to-noise ratio (SNR) value learned from the channel estimation data and determining whether to deploy the dynamically generated SRS configuration based on the confidence scores. If the confidence scores do not meet a predetermined threshold, the system may revert to a default SRS transmission configuration for the UE.

The method may also involve comparing physical-layer insights from multiple UEs and excluding at least one UE from a group of concurrently scheduled SRS transmissions if the UEs' channel insights are too similar or highly correlated, in order to minimize interference and optimize scheduling.

The machine-learned model may include a feature extraction pipeline configured to encode both frequency-domain and temporal dependencies in the channel estimation data, producing a latent encoded representation. The model may include a plurality of output heads, each trained to generate a specific physical-layer insight based on the encoded representation. The feature extraction pipeline may include, in sequence: a high-dimensional frequency spectrum encoder that captures correlations among subcarriers to produce a spectrum-encoded high-dimensional latent representation; a high-dimensional temporal encoder that models temporal dependencies across time slots based on the spectrum-encoded latent space; a high-to-low-dimensional frequency spectrum encoder that compresses the spectrum- and time-encoded high-dimensional latent representation into a lower-dimensional frequency representation; and a low-dimensional temporal encoder that encodes temporal relationships in the lower-dimensional space to produce a final compressed, spectrum- and time-encoded latent representation.

In some implementations, the high-dimensional temporal encoder may comprise a two-layer gated recurrent unit (GRU) model that retains time-series context across a predefined number of channel estimation periods. Each output head in the model may be implemented as a dense neural network configured to output a scalar metric representing a specific physical-layer insight.

These techniques may be implemented in hardware, in software stored on a computer-readable medium, or as part of a combined system including both hardware and software components.

In another general aspect, a system may include one or more hardware processors and one or more non-transitory machine-readable storage media encoded with instructions that, when executed by the hardware processors, cause the system to perform operations including: receiving, at a base station, channel estimation data associated with a UE; processing the data using a machine-learned model to derive physical-layer insights; determining an SRS transmission configuration based on the insights; generating a control message including the configuration; and transmitting the control message to the UE to update its SRS parameters. Variations of this aspect may be embodied in systems, devices, or software stored on computer-readable media configured to carry out the described operations.

In yet another general aspect, one or more non-transitory machine-readable storage media may store instructions that, when executed, perform operations including: receiving channel estimation data associated with a UE at a base station; processing the data through a machine-learned model to extract one or more physical-layer insights; determining, via a scheduler, an SRS transmission configuration based on the insights; generating a control message containing the configuration; and transmitting the message to the UE to update the SRS settings. These and other embodiments may be implemented in software, hardware, or a combination of both.

### BRIEF DESCRIPTION OF THE DRAWINGS

The technology disclosed herein, in accordance with one or more various embodiments, is described in detail with reference to the following figures (hereafter referred to as “FIGs”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A is an illustration of a Time Division Duplex (TDD) system where uplink Sounding Reference Signal (SRS) Transmission from multiple UEs to a Base Station.

FIG. 1B is an example illustration of a sounding reference signal in 5G networks, according to one embodiment.

FIG. 2 is an example illustration of a Layer 1 and Layer 2 architecture for SRS-based channel estimation and beamforming, according to one embodiment.

FIG. 3 is an example illustration of a dynamic SRS scheduling architecture based on derived physical layer insights, according to one embodiment.

FIG. 4A is an example illustration of a network model for the insight engine, according to one embodiment.

FIG. 4B is an example illustration of an information processing flow pipeline performed by the insight engine, according to one embodiment.

FIG. 5 illustrates an example use case demonstrating how the dynamic SRS scheduling architecture reduces uplink overhead while maintaining channel estimation accuracy using predictive modeling, according to one embodiment.

FIG. 6 is an illustration of a flowchart for adaptive channel prediction scheduling based on estimated doppler and discrete SRS periodicity constraints, according to one embodiment.

FIG. 7 is an illustration of an example method of dynamic SRS scheduling, according to one embodiment.

FIG. 8 illustrates an example computing system that may be used in implementing various features of embodiments of the disclosed technology.

### DETAILED DESCRIPTION

As briefly mentioned in the background section, 5G New Radio (NR) systems are designed to support high-throughput and low-latency wireless communication by leveraging advanced technologies such as massive Multiple Input Multiple Output (MIMO) and beamforming. One of the key features of 5G NR is multi-user MIMO (MU-MIMO), where multiple user equipment (UEs) are spatially multiplexed and served concurrently within the same time-frequency resources. This capability enables higher spectrum efficiency and overall network throughput.

In MU-MIMO configurations, the UE pairing procedure at the base station (BS) is critical to ensure that selected UEs exhibit minimal channel correlation. If two UEs have highly correlated channel responses, the signal-to-interference-plus-noise ratio (SINR) during simultaneous transmission may degrade significantly, thereby reducing overall throughput. To avoid such scenarios, the base station must obtain accurate and up-to-date channel estimates for each UE.

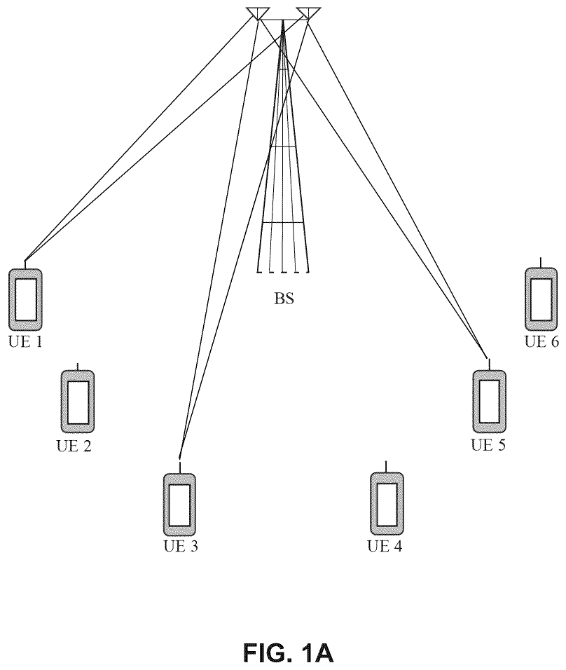

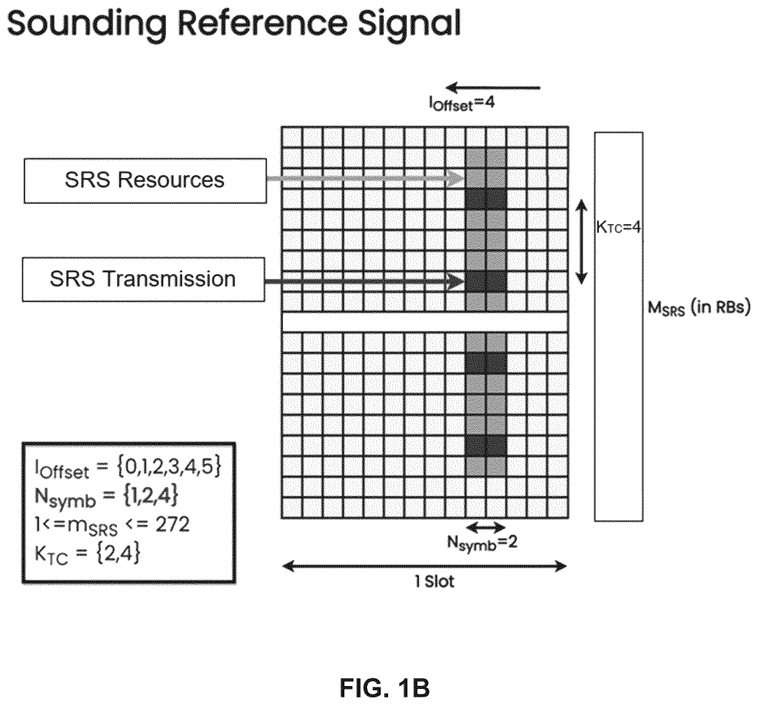

FIG. 1A is an illustration of a Time Division Duplex (TDD) system where uplink Sounding Reference Signal (SRS) Transmission from multiple UEs to a Base Station is shown. In TDD systems, uplink and downlink transmissions share the same frequency band but are separated in time, and based on the principle of channel reciprocity enables the use of uplink channel estimates for downlink transmission purposes.

To enable uplink-based channel estimation, 5G NR employs a dedicated uplink channel known as the Sounding Reference Signal (SRS). SRS signals are transmitted by the UEs to allow the base station to measure channel conditions and extract channel state information (CSI). These measurements are not only vital for beamforming and link adaptation but are also central to UE pairing decisions in MU-MIMO environments. Therefore, SRS transmission plays a central role in both link-level and system-level performance optimization in 5G NR networks.

The Layer 2 (L2) scheduler of the base station uses SRS-derived channel information to form UE pairs with low inter-user channel correlation, thereby optimizing spatial multiplexing and improving downlink throughput. The L2 scheduler also considers additional parameters such as SRS SINR, PRB (physical resource block) utilization, and modulation and coding scheme (MCS) selection.

In conventional 5G NR deployments, the SRS transmission schedule is statically configured, often with a fixed periodicity and a fixed resource allocation (e.g., number of resource elements (REs) per physical resource block (PRB)). This static configuration simplifies scheduling and ensures a consistent cadence for acquiring channel state information across the connected UEs.

Static SRS scheduling is commonly adopted because it avoids complexity and maintains backward compatibility with UEs operating under predefined configuration modes. Moreover, fixed periodicities are aligned with the network's discrete time frame structure, which includes standard slot intervals (e.g., 5, 10, 20, 40, or 80 slots), and they are easier to manage in large-scale deployments where many UEs must be simultaneously scheduled for both uplink and downlink operations.

However, this one-size-fits-all approach fails to account for the temporal and spatial diversity in radio conditions experienced by different UEs. For instance, a stationary UE in a low-mobility environment may not require SRS transmissions as frequently as a high-speed UE traversing a rapidly changing channel. Similarly, a UE experiencing a narrow delay spread might not need as many REs per PRB to obtain reliable channel estimates as a UE experiencing a wideband multipath channel. Applying the same SRS periodicity and resource allocation to all UEs leads to inefficient use of spectrum and increases UE power consumption unnecessarily.

FIG. 1B is an example illustration of a SRS allocation in 5G TDD networks, according to one embodiment. In TDD systems, uplink and downlink transmissions occur over the same frequency band but are separated in time. This time-domain separation allows the base station to exploit uplink SRS measurements for downlink transmission, leveraging the principle of channel reciprocity.

In the example shown, each uplink slot is represented as a two-dimensional time-frequency grid, with time on the horizontal axis (OFDM symbols) and frequency on the vertical axis (subcarriers). A subset of resource elements within this grid is allocated for SRS transmission. These resources are configurable in terms of the number of symbols (N_symb), the frequency-domain hopping or spacing (K_TC), and the time-domain offset (I_offset). As depicted, purple blocks represent the configured SRS resource elements, and red blocks indicate actual SRS transmissions by the UE.

In some embodiments, the SRS transmission occurs within a special slot designated by the base station. This slot includes a sequence of downlink (DL) symbols, followed by guard symbols, and then uplink (UL) symbols reserved exclusively for SRS transmission. Such a slot may be scheduled periodically (e.g., every 5 or 10 slots) or aperiodically, depending on system requirements. This dedicated structure ensures high-quality channel estimates for uplink and, by reciprocity, for downlink beamforming and scheduling decisions.

This flexible configuration allows the network to tailor SRS transmissions according to channel conditions and system needs. For example, increasing N_symb improves estimation resolution but consumes more uplink resources. Similarly, the frequency-domain spreading (K_TC) and time offset (I_offset) can be adjusted to balance estimation granularity and multiplexing efficiency.

The physical layer channel estimates derived from SRS transmissions are important for advanced uplink and downlink optimizations, including beamforming and user equipment (UE) pairing in MU-MIMO scenarios. As discussed with reference to the present invention, the SRS structure itself can be dynamically adapted based on physical-layer insights such as Doppler shift and delay spread. In such embodiments, the base station may adjust the periodicity of SRS transmissions and the number of resource elements per transmission based on real-time channel conditions, thereby improving link efficiency, reducing uplink overhead, and optimizing user scheduling.

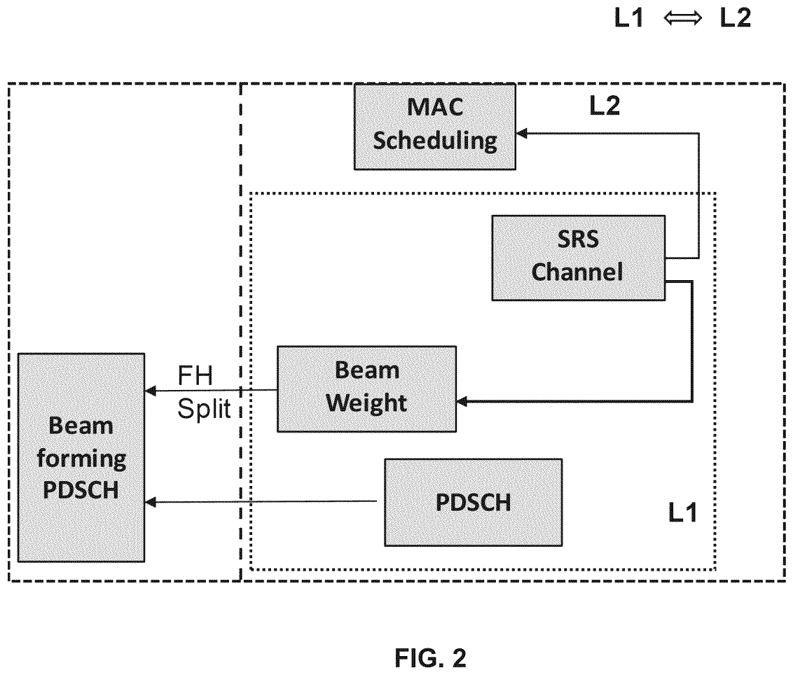

FIG. 2 is an example illustration of a Layer 1 and Layer 2 architecture for SRS-based channel estimation and beamforming, according to one embodiment. The architecture in FIG. 2 outlines the functional modules within a base station responsible for processing uplink SRS transmissions, generating channel estimates, and facilitating downlink data transmission and scheduling decisions.

In this example, Layer 1 (L1) encompasses the physical-layer processing chain, including the reception of SRS signals, derivation of beam weights, and preparation of physical downlink shared channel (PDSCH) transmissions. The SRS Channel block in L1 receives SRS transmissions from one or more user equipment (UEs) and computes corresponding channel estimates. These channel estimates are then passed to the Beam Weight module, which derives spatial precoding weights for the downlink based on the reciprocity of the TDD channel.

The resulting beam weights are applied to the PDSCH module to prepare beamformed downlink transmissions. A Beamforming PDSCH module is shown as an external block, separated by a functional split (denoted as “FH Split”) for fronthaul implementations where certain physical-layer functions are offloaded to a remote or distributed unit.

On the control-plane side, Layer 2 functionality (L2) includes the MAC Scheduling module, which is responsible for determining the transmission configuration for each UE, including scheduling of PDSCH resources and Sounding Reference Signal (SRS) transmission parameters. The MAC Scheduling module of the L2 receives channel estimation results derived from SRS signals via the SRS Channel, including information\about channel quality and dynamics and uses this information to update scheduling decisions and beamforming configurations.

The architecture in FIG. 2 highlights a limitation in existing systems. Current approaches to SRS scheduling are typically static: UEs are scheduled to transmit SRS periodically using fixed intervals (e.g., every 20 or 40 slots) without considering dynamic channel conditions. This static approach does not account for channel estimate aging or user-specific propagation conditions such as Doppler spread or delay spread. As a result, the system may either over-schedule SRS—leading to unnecessary UE transmissions and battery drain—or under-schedule it, leading to stale channel information and degraded link performance.

In an example, uplink SRS transmissions can incur a power cost of up to 23 dBm, significantly affecting UE battery life. However, in current systems, no adjustment is made to SRS periodicity based on channel dynamics such as Doppler shift or temporal stability. For example, a low-mobility UE might still transmit SRS at high frequency even though its channel remains stable over time, leading to wasteful power consumption. Conversely, high-mobility UEs may experience rapid channel variation that renders infrequent SRS updates ineffective for accurate downlink beamforming.

The present invention addresses these shortcomings by enabling dynamic SRS scheduling based on physical-layer insights, such as real-time Doppler estimation, delay spread, and channel quality (e.g., SNR). These insights allow L2 to adjust the SRS transmission configuration adaptively, reducing or increasing uplink overhead as needed, conserving UE battery life, and improving system capacity by freeing up SRS resources for other users.

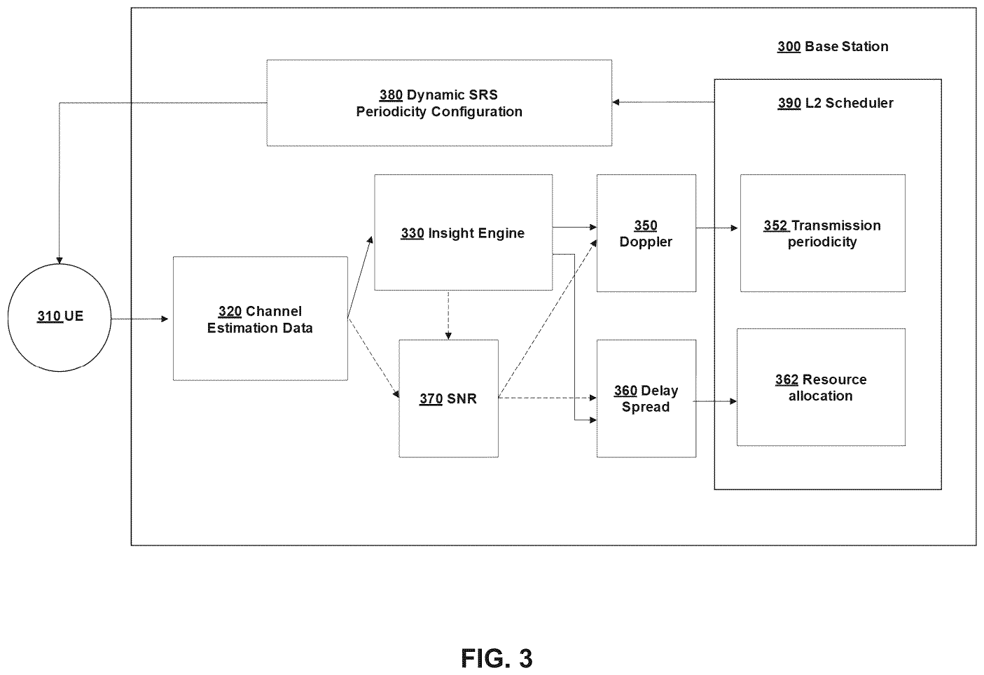

FIG. 3 is an example illustration of a dynamic SRS scheduling architecture based on derived physical layer insights, according to one embodiment. As shown, the system includes a base station 300 interacting with a user equipment (UE) 310.

In some embodiments, uplink data transmitted from UE 310 to base station 300 may include pilot signals, sounding reference signals (SRS), uplink control information (UCI), and other reference signals useful for estimating channel conditions. Channel estimation data 320 may be obtained at base station 300 by processing these uplink signals. In some embodiments, the channel estimation data 320 includes channel impulse response data, frequency-domain channel estimates, amplitude and phase characteristics across subcarriers, and channel quality indicators. Such channel estimation data may encapsulate the instantaneous and averaged measurements of the propagation channel between the UE and the base station antennas.

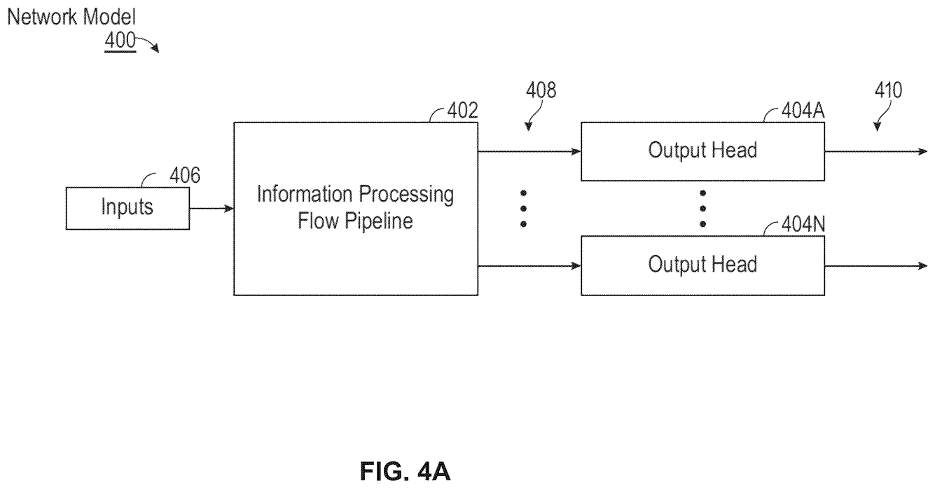

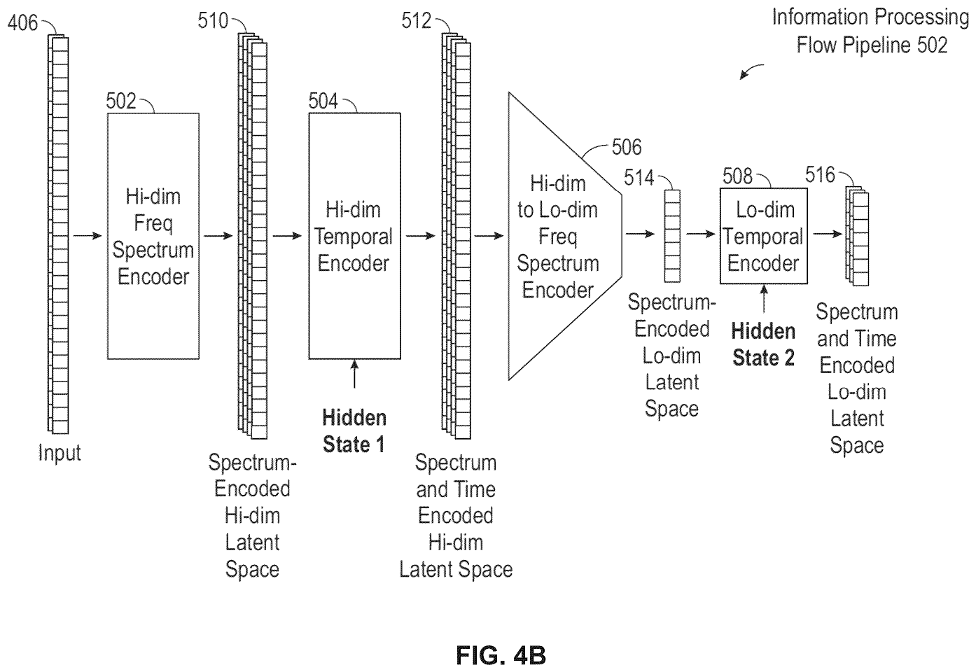

In some embodiments, the insight engine 330 employs a machine-learned model to process the channel estimation data 320 and generate critical physical-layer insights. More detailed descriptions of the insight engine 330 and its machine-learned model are provided with reference to FIGS. 4A and 4B. Briefly, the insight engine 330 implements a data transformation process comprising a high-dimensional frequency spectrum encoder, a high-dimensional temporal encoder, a high-to-low-dimensional frequency spectrum encoder, and a low-dimensional temporal encoder. These encoders sequentially extract frequency-domain correlations, temporal dependencies, and compress this information into a latent representation. Output heads implemented as dense neural networks (DNNs) receive this latent representation and produce scalar metrics for specific physical-layer insights such as Doppler estimates 350 and delay spread estimates 360.

In one embodiment, the signal-to-noise ratio (SNR) 370 is directly derived from amplitude and noise power information in the received channel estimation data 320. In another embodiment, the SNR 370 is inferred by the insight engine 330 itself by training one of its dedicated output heads to estimate the SNR based on patterns learned from historical channel data.

In some embodiments, the generated Doppler estimate 350 is utilized by an L2 scheduler 390 to determine the coherence time of the channel. In particular, the coherence time represents the duration over which the channel remains relatively unchanged, and is inversely proportional to the Doppler estimate. Based on this coherence time, the scheduler 390 selects an appropriate transmission periodicity 352 for the UE's SRS signals. In an example, the scheduler computes a predicted channel aging by multiplying the estimated Doppler frequency by the candidate transmission periodicity, which yields an expected variation in the channel conditions. This predicted channel aging is then compared to a predefined hysteresis threshold, which defines the maximum allowable channel variation for accurate channel estimation. If the predicted aging does not exceed this threshold, the candidate periodicity is selected, confirming alignment with current channel dynamics and ensuring minimal channel estimation errors.

For example, suppose the insight engine 330 estimates the UE's Doppler frequency to be approximately 10 Hz. If the scheduler is considering doubling the current SRS transmission periodicity from 40 slots to 80 slots, the scheduler calculates the predicted channel aging as the product of the Doppler estimate and the candidate periodicity. Assuming each slot corresponds to 0.5 ms, 80 slots equate to 40 ms. The predicted channel aging would thus be 10 Hz×40 ms=0.4 cycles. If the predefined hysteresis threshold for acceptable channel aging is set at 0.5 cycles, the predicted aging of 0.4 cycles remains within this allowable limit. Consequently, the scheduler approves the increased periodicity of 80 slots, confident that the channel conditions will not significantly degrade during this extended interval.

While the Doppler value is used to adjust the SRS transmission periodicity from a temporal perspective, the delay spread may be leveraged to optimize the SRS configuration from a frequency-domain perspective. In some embodiment, the delay spread estimate 360, which quantifies the multipath propagation effects in the wireless channel, is processed by the L2 scheduler 390 to determine the coherence bandwidth for the channel. Coherence bandwidth reflects the range of frequencies over which the channel remains highly correlated and is inversely proportional to the delay spread. The scheduler 390 then uses this coherence bandwidth metric to dynamically select the optimal number of resource elements per physical resource block (PRB) 362 allocated to each SRS transmission for the UE. Specifically, fewer resource elements may be allocated for lower delay spreads (higher coherence bandwidth), and more resource elements for higher delay spreads (lower coherence bandwidth). This dynamic and delay-spread-aware allocation allows the system to avoid allocating excessive subcarriers to SRS in high-coherence-bandwidth conditions, thereby freeing up those subcarriers for uplink data transmissions such as Physical Uplink Shared Channel (PUSCH) or control signaling. As a result, overall spectral efficiency is improved, uplink throughput is increased, and SRS overhead is minimized without compromising channel estimation accuracy.

In some embodiments, the SNR 370 serves a dual role—not only as a general indicator of link quality but also as a contributing factor to the reliability assessment of the physical-layer insights generated by the insight engine 330. While the SNR itself does not directly determine the confidence scores, it influences them by affecting the quality of the channel estimation data 320 that serves as input to the machine-learned model. Specifically, higher SNR values typically indicate cleaner, less noisy input signals, which improve the model's ability to generate stable and reliable Doppler and delay spread estimates. The insight engine 330 may compute confidence scores for both the Doppler estimate 350 and the delay spread estimate 360 using internal uncertainty metrics—such as softmax entropy, dropout-based variance during inference, or calibration curves derived during training. These confidence scores reflect the model's degree of certainty in its predictions and may be further conditioned on input features derived from the SNR, such as signal amplitude consistency, noise variance, and temporal stability across subcarriers.

In some embodiments, the L2 scheduler 390 evaluates each of these confidence scores against predefined thresholds tailored to the desired level of reliability for SRS scheduling decisions. For example, if the SNR is high (e.g., >15 dB) and the confidence scores exceed a target threshold (e.g., 0.95), the scheduler may determine that the Doppler and delay spread insights are sufficiently accurate to support dynamic SRS configuration. In such a case, the scheduler proceeds to deploy a tailored SRS transmission configuration 380, such as selecting a lower transmission periodicity for a fast-moving UE and adjusting frequency-domain resource allocation based on the inferred delay spread.

Conversely, in scenarios where the SNR is low (e.g., <5 dB), such as at the cell edge or during deep fading conditions, the insight engine may produce confidence scores below the acceptable threshold (e.g., <0.7). In such cases, the L2 scheduler 390 may opt not to trust the dynamically inferred insights. Instead, the scheduler falls back to a default SRS configuration designed to be robust under uncertainty—e.g., using a conservative periodicity (e.g., every 20 slots) and allocating a standard number of resource elements per PRB to ensure sufficient channel estimation quality regardless of prediction accuracy. This fallback mechanism safeguards against performance degradation due to erroneous insight-based configuration under poor radio conditions.

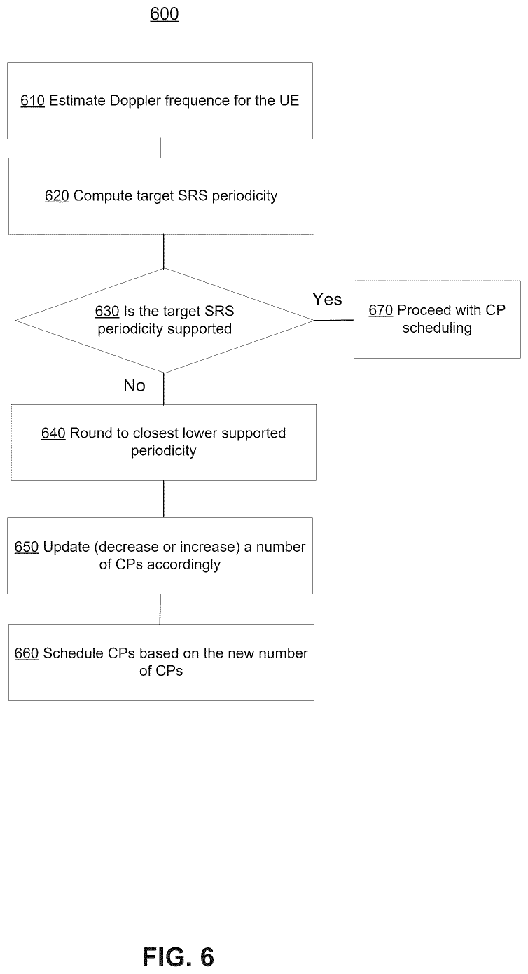

Furthermore, based on the determined transmission periodicity 352, the L2 scheduler 390 may further select and adjust the number of channel prediction intervals employed between consecutive SRS transmissions. This allows the base station 300 to reduce the frequency of SRS transmissions while maintaining accurate channel state information (CSI) through intermediate channel predictions. In some embodiments, the scheduler 390 computes the number of prediction intervals needed to span the selected periodicity and adapts the prediction strategy accordingly. This ensures alignment with the nearest standardized SRS periodicity supported by the physical layer (e.g., 40, 60, or 80 slots), minimizing the mismatch between the ideal coherence-driven periodicity and actual implementation constraints. The adjustment process also helps reduce redundant SRS overhead and computational load on the channel prediction module. Additional details on this prediction interval alignment and optimization are provided with reference to FIG. 6.

In some embodiments, the architecture further accommodates multiple UEs by comparing physical-layer insights—such as Doppler estimates, delay spread values, and SNR measurements—across a set of candidate UEs. These physical-layer insights are used to compute a pairwise channel correlation matrix that quantifies the spatial similarity between the channel estimates of each UE pair. The L2 scheduler 390 evaluates this matrix to determine which UEs exhibit high spatial correlation or similar propagation characteristics. For example, two UEs located in close proximity or experiencing similar scattering environments may produce channel estimates with a high degree of correlation, leading to poor orthogonality in the beamforming domain.

To avoid such performance degradation, the L2 scheduler 390 may apply a filtering or clustering algorithm (e.g., threshold-based exclusion, k-means grouping, or eigenvalue decomposition) to identify and exclude one or more UEs from the current SRS scheduling cycle. This ensures that concurrently scheduled UEs contribute sufficiently diverse channel responses, which enhances spatial multiplexing performance in MU-MIMO scenarios. By minimizing inter-user interference and improving beam separation, the system can achieve higher SINR levels and spectral efficiency, particularly in dense user environments.

In some embodiments, this filtering also accounts for QoS prioritization or traffic load balancing, enabling a tradeoff between spatial separation and throughput fairness. Thus, cross-UE physical-layer insight comparison not only improves MU-MIMO pairing but also supports adaptive and intelligent radio resource management.

In some embodiments, once the dynamic SRS periodicity configuration 380 is determined, the base station 300 generates and transmits a control message back to the UE 310. In some embodiments, this control message is embedded in downlink control information (DCI) and transmitted via the physical downlink control channel (PDCCH), or in some cases via higher-layer RRC signaling if the change is semi-static. The control message may include fields that explicitly define the updated SRS transmission periodicity, resource allocation (e.g., number of OFDM symbols and subcarriers), time and frequency offsets, and an activation time indicating when the new configuration is to take effect.

Upon receiving the control message, the UE 310 decodes and applies the new configuration to its SRS transmission. For example, the UE updates its MAC and PHY layer scheduling modules to reflect the adjusted SRS configuration, including timers and resource mapping tables. By aligning its uplink SRS transmissions with the newly assigned periodicity and resource structure, the UE not only complies with the network's scheduling decisions but also benefits from a transmission plan that is better matched to prevailing channel conditions.

As a result, this dynamic reconfiguration reduces unnecessary SRS transmissions—thereby lowering transmit power consumption—and ensures that channel estimation remains accurate without excessive signaling overhead. In scenarios where UEs experience slow channel variations (e.g., low mobility), this optimization significantly extends battery life. Conversely, in high-mobility scenarios, the tighter periodicity ensures channel tracking remains fresh, enabling reliable beamforming and data scheduling decisions at the base station.

FIG. 4A illustrates a network model 400 representing the core architecture of the insight engine 330 described with reference to FIG. 3. This architecture leverages a machine-learned model to process input data and generate physical-layer insights used in dynamically configuring SRS scheduling parameters.

As shown, the network model 400 comprises an input layer 406, an information processing flow pipeline 402, and a plurality of output heads 404A through 404N. The input layer 406 receives channel-related data, which in some embodiments includes channel estimation measurements derived from uplink sounding reference signals (SRS) received at the base station. The input data may include complex-valued vectors representing the amplitude and phase of each subcarrier over multiple OFDM symbols and may optionally include other parameters such as historical SRS data, signal quality indicators, or slot-level metadata. In some embodiments, the input dimension may be on the order of 3276×2 per channel estimation period, capturing both real and imaginary components across all subcarriers.

In some embodiments, the information processing flow pipeline 402 performs high-dimensional feature extraction and temporal pattern recognition over the input data 406. This pipeline 402 applies a cascade of deep neural network layers—including convolutional neural networks (CNNs) and recurrent layers such as gated recurrent units (GRUs)—to encode both frequency-domain and time-domain dependencies in the channel observations. The output 408 of this pipeline is a set of high-level feature representations that compress and preserve the salient information needed to infer channel behavior.

These feature representations in the output 408 are then dispatched to a set of specialized output heads 404A through 404N. Each output head is configured to estimate a specific physical-layer insight, such as Doppler frequency, delay spread, or SNR. In some embodiments, each output head is implemented as a dense neural network (DNN) trained independently using supervised learning, with labels derived from simulation or real-world measurements. The output 410 of each head is a scalar value corresponding to the respective insight, which is later used by the L2 scheduler for dynamic SRS configuration as described earlier.

FIG. 4B illustrates an example embodiment of the information processing flow pipeline 502, forming the core of the insight engine 330 discussed previously with reference to FIG. 4A. This pipeline is configured to transform input channel estimation data 406 into a compressed and insight-rich latent representation suitable for inference by the output heads of FIG. 4A.

In some embodiments, the input 406 comprises a multidimensional tensor encoding raw or pre-processed channel estimation data. This data may include complex-valued measurements (real and imaginary parts) from received uplink SRS transmissions over multiple OFDM subcarriers and time slots. The input shape may, for example, be 3276×2×T, representing 3276 subcarriers, real/imaginary components, and T consecutive channel estimation periods.

The first processing stage is a high-dimensional frequency spectrum encoder 502, which extracts spatial correlations among subcarriers within each time slot. In some embodiments, the encoder 502 is implemented as a convolutional neural network (CNN) configured to model frequency-domain relationships such as phase coherence and amplitude similarity between subcarriers. The output of this stage is a spectrum-encoded high-dimensional latent space 510 that captures fine-grained spectral features.

This latent representation 510 is then passed to a high-dimensional temporal encoder 504, which models temporal dependencies across channel estimation periods. In some embodiments, encoder 504 comprises a two-layer gated recurrent unit (GRU) network that processes the sequence of latent frequency vectors over time. The GRU produces a spectrum- and time-encoded high-dimensional latent space 512. The internal hidden state of this GRU, indicated as Hidden State 1, encodes temporal memory across multiple time steps and contributes to the model's ability to track evolving channel dynamics.

To reduce computational burden while retaining critical features, the high-dimensional representation 512 is compressed using a high-to-low-dimensional frequency spectrum encoder 506. In some embodiments, this encoder is a multi-layer CNN that condenses frequency-domain information into a smaller number of abstracted features, generating a spectrum-encoded low-dimensional latent space 514.

The compressed data 514 is further processed by a low-dimensional temporal encoder 508, which may also be implemented as a GRU. This encoder refines the temporal modeling at the lower feature dimensionality, producing a final spectrum- and time-encoded latent space 516. The internal state of this GRU, labeled Hidden State 2, retains the temporal context across compressed representations and ensures smooth tracking of time-varying channel metrics such as Doppler frequency and delay spread.

This final encoded representation 516 is forwarded to the output heads (e.g., Doppler, delay spread, SNR), which generate scalar insight values as described in FIG. 4A.

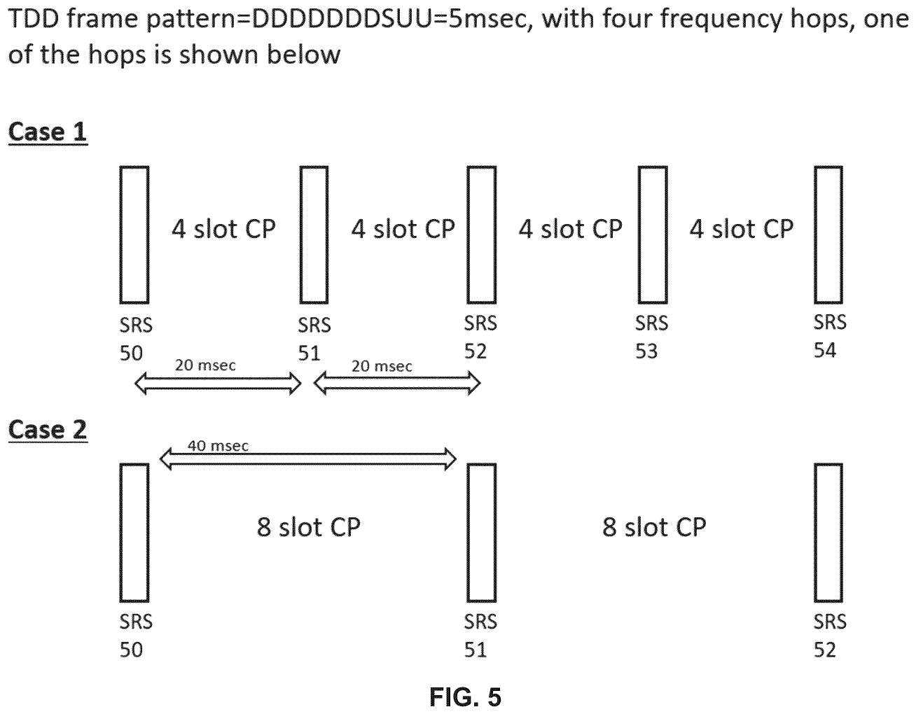

FIG. 5 illustrates an example use case demonstrating how the dynamic SRS scheduling architecture reduces uplink overhead while maintaining channel estimation accuracy using predictive modeling, according to one embodiment.

The figure includes two alternative SRS scheduling scenarios—Case 1 and Case 2—both of which are evaluated under the same physical-layer conditions but apply different SRS periodicities and prediction intervals.

In Case 1, SRS transmissions are configured with a periodicity of 20 milliseconds (equivalent to 40 slots in numerology 1). Each SRS instance is followed by a 4-slot channel prediction (CP) interval, after which a new SRS transmission is received. This case reflects a baseline periodic configuration commonly used to support UEs with moderate Doppler values, where the aging of the channel estimate is tolerable within the 20 ms window and regular SRS updates are needed for maintaining estimation fidelity.

In Case 2, the system exploits the fact that the UE's Doppler frequency has been estimated to be low (e.g., 10 Hz), indicating that the channel varies slowly. As such, the system can extend the SRS transmission periodicity to 40 milliseconds (i.e., 80 slots), while increasing the channel prediction interval to 8 slots. This configuration effectively doubles the time between SRS transmissions while maintaining a prediction resolution equivalent to the 20 ms/4-slot scenario. That is, the slower channel evolution at 10 Hz mimics the impact of a 20 Hz channel when the observation window is doubled, allowing the same channel prediction model (previously tested to perform well at 20 Hz with 4 predictions) to operate within its valid predictive range.

This adaptation is enabled by the insight engine described in FIGS. 3 and 4A-4B, which generates accurate Doppler estimates based on real-time channel estimation data. The L2 scheduler dynamically selects a longer SRS periodicity and updates the number of required prediction intervals accordingly, aligning the configuration with predefined SRS periodicity values (e.g., 20, 40, 60, 80 slots) supported in 5G NR.

This flexibility leads to tangible technical improvements. First, it reduces the number of SRS transmissions needed from the UE, thus conserving battery life and uplink bandwidth. Second, the saved SRS transmission resources can be reallocated to other uplink data or control channels, enhancing spectrum efficiency. Third, it prevents unnecessary SRS overhead in scenarios where the physical channel conditions do not require frequent updates, contributing to an overall more adaptive and efficient radio access strategy.

FIG. 6 is an illustration of a flowchart 600 for adaptive channel prediction scheduling based on estimated doppler and discrete SRS periodicity constraints, according to one embodiment. The flowchart 600 shown enables the system to reconcile ideal, insight-driven SRS scheduling with the discrete periodicities permitted by the 5G NR standard (e.g., 5, 10, 20, 40, 60, 80 slots).

At block 610, the base station estimates the Doppler frequency for a given UE using physical-layer insights generated by the insight engine, as described with reference to FIGS. 3, 4A, and 4B. The Doppler value serves as an indicator of the rate of channel variation over time, which is used to determine how frequently the UE's channel state must be refreshed using SRS or CPs.

At block 620, a target SRS periodicity is computed based on the estimated Doppler. For example, if the insight engine determines that the UE has a Doppler of 11 Hz and the prediction model is known to be accurate for Doppler values up to 20 Hz with four predictions, then the system may compute a target periodicity of approximately 72.7 slots.

Block 630 determines whether this computed periodicity exactly matches one of the supported SRS periodicity values. Since 72.7 is not among the standard periodicities supported in 5G NR (e.g., 20, 40, 60, 80), the answer in this case is “No.”

In response, the system proceeds to block 640, where it rounds the target periodicity down to the nearest lower supported periodicity (e.g., 60 slots in the example). This ensures compatibility with the SRS configuration table while minimizing deviation from the optimal prediction interval.

At block 650, the number of CPs (channel prediction intervals) is decreased or increased proportionally to align with the new periodicity. For instance, if the original plan required four CPs at 18.2 slots each (to cover 72.7 slots), the new plan might use three CPs at 18.2 slots to cover approximately 54.6 slots, which closely fits within the rounded-down 60-slot window. Conversely, if the target periodicity were computed as 66.2 slots and rounded up to the nearest supported periodicity of 80 slots, the number of CPs may be increased from four to five, resulting in five CPs spaced approximately 16.6 slots apart to maintain temporal granularity across the longer window while still ensuring timely channel predictions.

Finally, at block 660, the system schedules the CPs based on the updated count and interval. This ensures that channel prediction continues to fill in the temporal gaps between SRS transmissions while complying with periodicity constraints and without introducing excessive prediction overhead.

If, in block 630, the computed periodicity does match a supported value, the flow proceeds to block 670, where CP scheduling continues using the originally intended number of intervals and spacing.

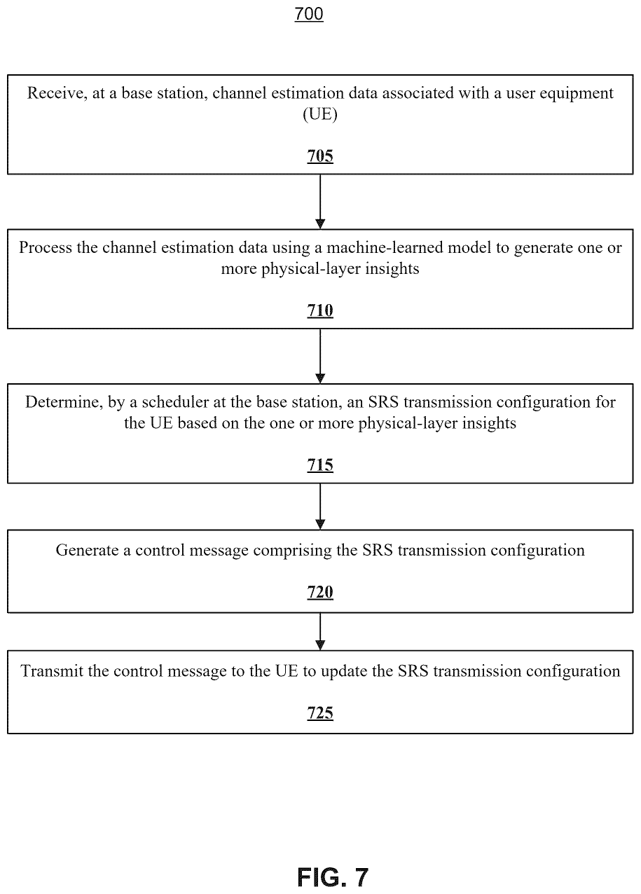

FIG. 7 is a flowchart of an example process 700. In some implementations, one or more blocks of FIG. 7 may be performed by a device such as a base station.

As shown in FIG. 7, process 700 may begin by receiving, at a base station, channel estimation data associated with a user equipment (UE) (block 705). For example, the device may receive channel estimation data derived from uplink sounding reference signals (SRS), as described above. The process may continue with processing the channel estimation data using a machine-learned model to generate one or more physical-layer insights (block 710). These insights may include Doppler values, delay spread values, or signal-to-noise ratio (SNR), inferred through a trained network model based on temporal and frequency-domain channel patterns.

At block 715, the base station's scheduler determines an SRS transmission configuration for the UE based on the generated physical-layer insights. The configuration may include the SRS transmission periodicity and/or the allocation of physical resource elements for SRS. Next, at block 720, the device generates a control message comprising the SRS transmission configuration. At block 725, this control message is transmitted to the UE to instruct it to update its SRS configuration according to the computed settings.

In some implementations, the SRS transmission configuration includes one or both of a transmission periodicity and a resource allocation. Based on the computed transmission periodicity, the system may further select the number of channel prediction intervals to be used between consecutive SRS transmissions. The number of prediction intervals may then be adjusted to align with supported discrete periodicity values. If the initially computed periodicity is not directly supported, the system may round it to the nearest lower supported value from a predefined set of allowed periodicities.

The physical-layer insights generated by the model may include a Doppler value and a delay spread value. In one scenario, the Doppler value is used to determine the channel's coherence time, and this coherence time is then used to select the SRS transmission periodicity. In another scenario, a predicted channel aging is computed based on the Doppler value and a candidate SRS periodicity. The predicted aging is compared to a predefined hysteresis threshold, and if it does not exceed that threshold, the candidate periodicity is accepted.

The delay spread value may be used to estimate the channel's coherence bandwidth, which in turn guides the selection of the number of resource elements per physical resource block (PRB) allocated to SRS transmission. Higher delay spread implies lower coherence bandwidth, which may require allocating more resource elements per PRB.

In some embodiments, the SNR is used to compute confidence scores for both the Doppler and delay spread values. These confidence scores indicate the reliability of the inferred insights. The scheduler may choose to apply the dynamically generated SRS configuration only when the confidence scores exceed a defined threshold. If the scores fall below the threshold, a default SRS configuration may be applied instead.

Further, the system may compare physical-layer insights from multiple UEs. UEs with highly correlated channel characteristics may be excluded from concurrent SRS scheduling to avoid inter-user interference and optimize system-level throughput.

The machine-learned model used in process 700 includes a feature extraction pipeline that encodes both frequency-domain and temporal dependencies in the channel estimation data to produce an encoded representation. This pipeline includes a high-dimensional frequency spectrum encoder that models correlations across subcarriers, followed by a high-dimensional temporal encoder (e.g., a two-layer gated recurrent unit or GRU) that tracks time-domain dependencies across slots. The combined representation may be compressed through a high-to-low-dimensional frequency spectrum encoder and refined via a low-dimensional temporal encoder to form the final latent representation used for inference.

Each output head in the model may be a dense neural network trained to predict a scalar value representing a specific insight, such as Doppler, delay spread, or SNR.

Although FIG. 7 illustrates specific steps and ordering, in alternative implementations, process 700 may include additional blocks, fewer blocks, or blocks performed in a different sequence. Two or more blocks may also be executed in parallel, depending on system design and deployment architecture.

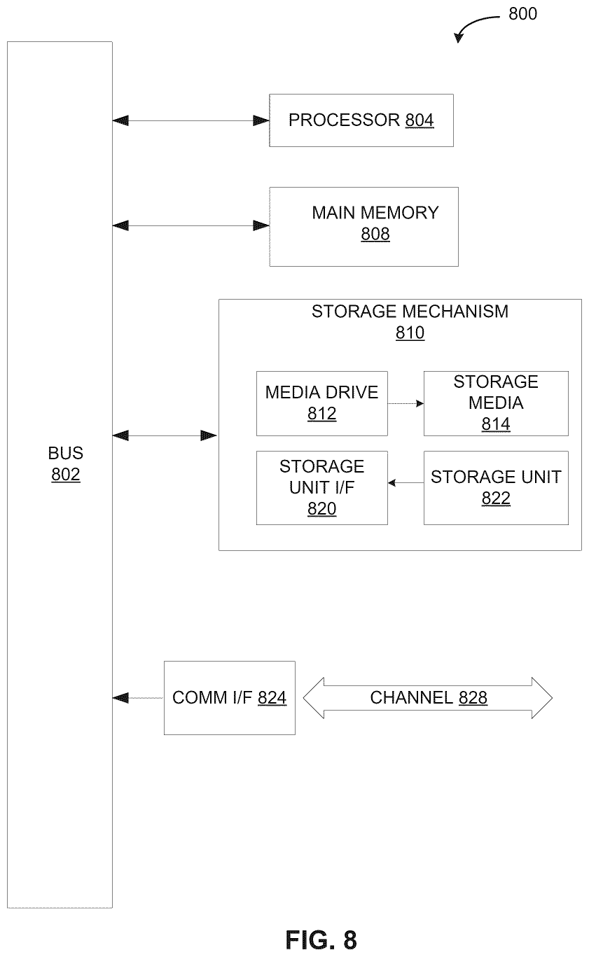

FIG. 8 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for dynamically scheduling sounding reference signals (SRS) in a wireless communication system, the method comprising:
receiving channel estimation data associated with a user equipment (UE);
processing the channel estimation data using a machine-learned model to generate one or more physical-layer insights;
determining an SRS transmission configuration for the UE based on the one or more physical-layer insights;
generating a control message comprising the SRS transmission configuration; and
transmitting the control message to the UE to update the SRS transmission configuration.

2. The method of claim 1, wherein the SRS transmission configuration comprises at least one of a transmission periodicity and a resource allocation.

3. The method of claim 1, wherein the one or more physical-layer insights comprise at least one of a Doppler value and a delay spread value.

4. The method of claim 3, wherein the determining the SRS transmission configuration comprises:
determining, based on the Doppler value, a coherence time for the wireless channel; and
selecting, based on the coherence time, a transmission periodicity for SRS signals for the UE.

5. The method of claim 3, wherein the determining the SRS transmission configuration comprises:
computing, based on the Doppler value, a predicted channel aging over a candidate transmission periodicity for SRS signals;
comparing the predicted channel aging to a predefined hysteresis threshold; and
selecting the candidate transmission periodicity for SRS signals for the UE in response to that the predicted channel aging does not exceed the predefined hysteresis threshold.

6. The method of claim 3, wherein determining the SRS transmission configuration comprises:
determining, based on the delay spread value, a coherence bandwidth for the UE; and
selecting, based on the coherence bandwidth, a number of resource elements per physical resource block (PRB) to be allocated for SRS transmission for the UE.

7. The method of claim 3, further comprising:
determining, based on a signal-to-noise ratio (SNR) value learned from the channel estimation data, confidence scores for the Doppler value and the delay spread value; and
determining whether to deploy the SRS transmission configuration based on the confidence scores.

8. The method of claim 7, further comprising:
in response to determining that the confidence scores do not meet a predetermined threshold, selecting a default SRS transmission configuration for the UE.

9. The method of claim 2, further comprising:
selecting a number of channel prediction intervals to be used between consecutive SRS transmissions based on the transmission periodicity; and
adjusting the number of channel prediction intervals in response to aligning the transmission periodicity with a supported SRS periodicity value.

10. The method of claim 3, further comprising:
comparing physical-layer insights associated with a plurality of UEs; and
excluding at least one UE from a group of concurrently scheduled UEs for SRS transmission based on similarity or correlation between the physical-layer insights.

11. The method of claim 2, further comprising:
adjusting the transmission periodicity to a closest supported value from a predefined set of SRS periodicities

12. The method of claim 1, the machine-learned model comprising:
a feature extraction pipeline configured to encode frequency-domain and temporal dependencies in the channel estimation data to obtain an encoded representation; and
a plurality of output heads, each output head configured to generate a respective physical-layer insight based on the encoded representation.

13. The method of claim 12, wherein the feature extraction pipeline comprises:
encoding, using a high-dimensional frequency spectrum encoder, frequency-domain correlations among a plurality of subcarriers in the channel estimation data to generate a spectrum-encoded high-dimensional latent representation.

14. The method of claim 13, wherein the feature extraction pipeline further comprises:
encoding, using a high-dimensional temporal encoder, temporal dependencies across a plurality of time slots based on the spectrum-encoded high-dimensional latent representation.

15. The method of claim 14, wherein the feature extraction pipeline further comprises:
compressing the spectrum- and time-encoded high-dimensional latent representation using a high-to-low-dimensional frequency spectrum encoder to generate a lower-dimensional frequency representation.

16. The method of claim 15, wherein the feature extraction pipeline further comprises:
encoding, using a low-dimensional temporal encoder, temporal dependencies in the lower-dimensional frequency representation to produce a compressed spectrum- and time-encoded latent representation.

17. The method of claim 12, wherein each output head of the machine-learned model comprises a dense neural network configured to output a scalar metric representing a physical-layer insight.

18. The method of claim 14, wherein the high-dimensional temporal encoder comprises a two-layer gated recurrent unit (GRU) model configured to retain time-series context across a predefined number of channel estimation periods.

19. A system, comprising:
one or more hardware processors; and
one or more non-transitory machine-readable storage media encoded with instructions that, when executed by the one or more hardware processors, cause the system to perform operations comprising:
receiving channel estimation data associated with a user equipment (UE);
processing the channel estimation data using a machine-learned model to generate one or more physical-layer insights;
determining an SRS transmission configuration for the UE based on the one or more physical-layer insights;
generating a control message comprising the SRS transmission configuration; and
transmitting the control message to the UE to update the SRS transmission configuration.

20. One or more non-transitory machine-readable storage media encoded with instructions that, when executed by one or more hardware processors of a computing system, cause the computing system to perform operations comprising:
receiving channel estimation data associated with a user equipment (UE);
processing the channel estimation data using a machine-learned model to generate one or more physical-layer insights;
determining an SRS transmission configuration for the UE based on the one or more physical-layer insights;
generating a control message comprising the SRS transmission configuration; and
transmitting the control message to the UE to update the SRS transmission configuration.
